(19) United States
(12) Patent Application Publication
(10) Pub. No.: US 2025/0106584 A1
(43) Pub. Date: Mar. 27, 2025

(54) Adjustment of Reverberator Based on Input Diffuse-to-Direct Ratio

(71) Applicant: Nokia Technologies Oy, Espoo (FI)

(72) Inventors: Antti Johannes ERONEN, Tampere (FI); Sujeet Shyamsundar MATE, Tampere (FI); Werner DE BRUIJN, Stockholm (SE)

(21) Appl. No.: 18/727,477

(22) PCT Filed: Jan. 2, 2023
(86) PCT No.: PCT/FI2023/050002

§ 371 Date: Jul. 9, 2024

(30) Foreign Application Priority Data
Jan. 12, 2022 (GB) 2200335.4

(51) Int. Cl. H04S 7/00; G10K 15/08

(52) U.S. Cl. CPC H04S 7/305; G10K 15/08

(57) ABSTRACT

An apparatus for assisting spatial rendering for room acoustics, the apparatus including circuitry configured to: obtain at least one reverberation parameter; determine at least one reverberation ratio parameter at least based on the obtained at least one reverberation parameter; adjust the at least one reverberation ratio parameter; obtain at least one audio signal; and control late reverberation ratio of the obtained at least one audio signal based on the adjusted at least one reverberation ratio parameter.

### FIELD

The present application relates to apparatus and methods for spatial audio reproduction by the adjustment of reverberators based on input diffuse-to-direct ratio (DDR) values, but not exclusively for spatial audio reproduction by the adjustment of reverberators based on input DDR values in augmented reality and/or virtual reality apparatus.

### BACKGROUND

Reverberation refers to the persistence of sound in a space after the actual sound source has stopped. Different spaces are characterized by different reverberation characteristics. For conveying spatial impression of an environment, reproducing reverberation perceptually accurately is important. Room acoustics are often modelled with individually synthesized early reflection portion and a statistical model for the diffuse late reverberation. FIG. 1 depicts an example of a synthesized room impulse response where the direct sound 101 is followed by discrete early reflections 103 which have a direction of arrival (DOA) and diffuse late reverberation 105 which can be synthesized without any specific direction of arrival. The delay d1(t) 102 in FIG. 1 can be seen to denote the direct sound arrival delay from the source to the listener and the delay d2(t) 104 can denote the delay from the source to the listener for one of the early reflections (in this case the first arriving reflection).

One method of reproducing reverberation is to utilize a set of N loudspeakers (or virtual loudspeakers reproduced binaurally using a set of head-related transfer functions (HRTF)). The loudspeakers are positioned around the listener somewhat evenly. Mutually incoherent reverberant signals are reproduced from these loudspeakers, producing a perception of surrounding diffuse reverberation.

The reverberation produced by the different loudspeakers has to be mutually incoherent. In a simple case the reverberations can be produced using the different channels of the same reverberator, where the output channels are uncorrelated but otherwise share the same acoustic characteristics such as RT60 time and level (specifically, the diffuse-to-direct ratio or reverberant-to-direct ratio). Such uncorrelated outputs sharing the same acoustic characteristics can be obtained, for example, from the output taps of a Feedback-Delay-Network (FDN) reverberator with suitable tuning of the delay line lengths, or from a reverberator based on using decaying uncorrelated noise sequences by using a different uncorrelated noise sequence in each channel. In this case, the different reverberant signals effectively have the same features, and the reverberation is typically perceived to be similar to all directions.

Reverberation spectrum or level can be controlled using the diffuse-to-direct ratio (DDR), which describes the ratio of the energy (or level) of reverberant sound energy to the direct sound energy (or the total emitted energy of a sound source).

### SUMMARY

There is provided according to a first aspect an apparatus for for assisting spatial rendering for room acoustics, the apparatus comprising means configured to: obtain at least one reverberation parameter; determine at least one reverberation ratio parameter at least based on the obtained at least one reverberation parameter; adjust the at least one reverberation ratio parameter; obtain at least one audio signal; and control late reverberation ratio of the obtained at least one audio signal based on the adjusted at least one reverberation ratio parameter.

The means configured to control late reverberation ratio of the obtained at least one audio signal based on the adjusted at least one reverberation ratio parameters may be configured to: provide a filter configured based on the at least one adjusted reverberation ratio parameter; and apply the filter to the at least one audio signal to generate a late-rendered part of a rendered audio signal.

The means configured to obtain reverberation parameters may be configured to obtain information which indicates whether to use an input reverberation ratio or a ratio calculated based on at least one reverberation parameter.

The means configured to obtain reverberation parameters may be configured to obtain at least one of: at least one RT60 time; at least one room or enclosure volume dimension; at least one pre-delay value; and at least one diffuse-to-direct ratio value.

The means configured to obtain at least one pre-delay value may be further configured to: obtain at least one pre-delay value; and determine a further predelay value from the first predelay value.

The means configured to determine at least one reverberation ratio parameter at least based on the obtained at least one reverberation parameter may be configured to set the determined at least one reverberation ratio parameter as the at least one reverberation parameter.

The means configured to adjust the at least one reverberation ratio parameter may be configured to: obtain at least one value; and apply the at least one value to the at least one reverberation ratio parameter to obtain at least one adjusted reverberation ratio parameter.

The at least one value may comprise a decibel offset for the at least one reverberation ratio parameter.

The means configured to adjust the at least one reverberation ratio parameter may be configured to determine an approximation polynomial, the approximation polynomial configured to approximate a decay of reverberation energy.

The approximation polynomial may be one of: a first order polynomial; a second order polynomial; and a third order polynomial.

The at least one reverberation ratio parameter may comprise at least one of: at least one late reverberation level parameters; at least one late reverberation energy ratio; at least one diffuse-to-total ratio; at least one reverberant-to-direct ratio, therein the reverberant-to-direct ratio is measured as level or energy; at least one total-to-diffuse ratio; and at least one direct-to-reverberant ratio.

According to a second aspect there is provided a method for an apparatus for assisting spatial rendering for room acoustics, the method comprising: obtaining at least one reverberation parameter; determining at least one reverberation ratio parameter at least based on the obtained at least one reverberation parameter; adjusting the at least one reverberation ratio parameter; obtaining at least one audio signal; and controlling late reverberation ratio of the obtained at least one audio signal based on the adjusted at least one reverberation ratio parameter.

Controlling late reverberation ratio of the obtained at least one audio signal based on the adjusted at least one reverberation ratio parameters may comprise: providing a filter configured based on the at least one adjusted reverberation ratio parameter; and applying the filter to the at least one audio signal to generate a late-rendered part of a rendered audio signal.

Obtaining reverberation parameters may comprise obtaining information which indicates whether to use an input reverberation ratio or a ratio calculated based on at least one reverberation parameter.

Obtaining reverberation parameters may comprise obtaining at least one of: at least one RT60 time; at least one room or enclosure volume dimension; at least one pre-delay value; and at least one diffuse-to-direct ratio value.

Obtaining at least one pre-delay value may comprise: obtaining at least one pre-delay value; and determining a further predelay value from the first predelay value.

Determining at least one reverberation ratio parameter at least based on the obtained at least one reverberation parameter may comprise setting the determined at least one reverberation ratio parameter as the at least one reverberation parameter.

Adjusting the at least one reverberation ratio parameter may comprises: obtaining at least one value; and applying the at least one value to the at least one reverberation ratio parameter to obtain at least one adjusted reverberation ratio parameter.

The at least one value may comprise a decibel offset for the at least one reverberation ratio parameter.

Adjusting the at least one reverberation ratio parameter may comprise determining an approximation polynomial, the approximation polynomial configured to approximate a decay of reverberation energy.

The approximation polynomial may be one of: a first order polynomial; a second order polynomial; and a third order polynomial.

The at least one reverberation ratio parameter may comprise at least one of: at least one late reverberation level parameters; at least one late reverberation energy ratio; at least one diffuse-to-total ratio; at least one reverberant-to-direct ratio, therein the reverberant-to-direct ratio is measured as level or energy; at least one total-to-diffuse ratio; and at least one direct-to-reverberant ratio.

According to a third aspect there is provided an apparatus for assisting spatial rendering for room acoustics, the apparatus comprising at least one processor and at least one memory including a computer program code, the at least one memory and the computer program code configured to, with the at least one processor, cause the apparatus at least to: obtain at least one reverberation parameter; determine at least one reverberation ratio parameter at least based on the obtained at least one reverberation parameter; adjust the at least one reverberation ratio parameter; obtain at least one audio signal; and control late reverberation ratio of the obtained at least one audio signal based on the adjusted at least one reverberation ratio parameter.

The apparatus caused to control late reverberation ratio of the obtained at least one audio signal based on the adjusted at least one reverberation ratio parameters may be caused to: provide a filter configured based on the at least one adjusted reverberation ratio parameter; and apply the filter to the at least one audio signal to generate a late-rendered part of a rendered audio signal.

The apparatus caused to obtain reverberation parameters may be caused to obtain information which indicates whether to use an input reverberation ratio or a ratio calculated based on at least one reverberation parameter.

The apparatus caused to obtain reverberation parameters may be caused to obtain at least one of: at least one RT60 time; at least one room or enclosure volume dimension; at least one pre-delay value; and at least one diffuse-to-direct ratio value.

The apparatus caused to obtain at least one pre-delay value may be further caused to: obtain at least one pre-delay value; and determine a further predelay value from the first predelay value.

The apparatus caused to determine at least one reverberation ratio parameter at least based on the obtained at least one reverberation parameter may be caused to set the determined at least one reverberation ratio parameter as the at least one reverberation parameter.

The apparatus caused to adjust the at least one reverberation ratio parameter may be caused to: obtain at least one value; and apply the at least one value to the at least one reverberation ratio parameter to obtain at least one adjusted reverberation ratio parameter.

The at least one value may comprise a decibel offset for the at least one reverberation ratio parameter.

The apparatus caused to adjust the at least one reverberation ratio parameter may be caused to determine an approximation polynomial, the approximation polynomial configured to approximate a decay of reverberation energy.

The approximation polynomial may be one of: a first order polynomial; a second order polynomial; and a third order polynomial.

The at least one reverberation ratio parameter may comprise at least one of: at least one late reverberation level parameters; at least one late reverberation energy ratio; at least one diffuse-to-total ratio; at least one reverberant-to-direct ratio, therein the reverberant-to-direct ratio is measured as level or energy; at least one total-to-diffuse ratio; and at least one direct-to-reverberant ratio.

According to a fourth aspect there is provided an apparatus comprising: obtaining circuitry configured to obtain at least one reverberation parameter; determining circuitry configured to determine at least one reverberation ratio parameter at least based on the obtained at least one reverberation parameter; adjusting circuitry configured to adjust the at least one reverberation ratio parameter; obtaining circuitry configured to obtain at least one audio signal; and controlling circuitry configured to control late reverberation ratio of the obtained at least one audio signal based on the adjusted at least one reverberation ratio parameter.

According to a fifth aspect there is provided a computer program comprising instructions [or a computer readable medium comprising program instructions] for causing an apparatus to perform at least the following: obtain at least one reverberation parameter; determine at least one reverberation ratio parameter at least based on the obtained at least one reverberation parameter; adjust the at least one reverberation ratio parameter; obtain at least one audio signal; and control late reverberation ratio of the obtained at least one audio signal based on the adjusted at least one reverberation ratio parameter.

According to a sixth aspect there is provided a non-transitory computer readable medium comprising program instructions for causing an apparatus to perform at least the following: obtain at least one reverberation parameter; determine at least one reverberation ratio parameter at least based on the obtained at least one reverberation parameter; adjust the at least one reverberation ratio parameter; obtain at least one audio signal; and control late reverberation ratio of the obtained at least one audio signal based on the adjusted at least one reverberation ratio parameter.

According to a seventh aspect there is provided an apparatus comprising: means for obtaining at least one reverberation parameter; means for determining at least one reverberation ratio parameter at least based on the obtained at least one reverberation parameter; means for adjusting the at least one reverberation ratio parameter; means for obtaining at least one audio signal; and means for controlling late reverberation ratio of the obtained at least one audio signal based on the adjusted at least one reverberation ratio parameter.

According to an eighth aspect there is provided a computer readable medium comprising program instructions for causing an apparatus to perform at least the following: obtain at least one reverberation parameter; determine at least one reverberation ratio parameter at least based on the obtained at least one reverberation parameter; adjust the at least one reverberation ratio parameter; obtain at least one audio signal; and control late reverberation ratio of the obtained at least one audio signal based on the adjusted at least one reverberation ratio parameter.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows a model of room acoustics and the room impulse response;

FIG. 2 shows a graph of energy decay in a perfectly diffuse field;

FIG. 3 shows schematically an example apparatus within which some embodiments may be implemented;

FIG. 4 shows a flow diagram of the operation of the example apparatus as shown in FIG. 3;

FIG. 5 shows schematically an example DDR based reverberation gain determiner as shown in FIG. 3 according to some embodiments;

FIG. 6 shows a flow diagram of the operation of the example directivity-influenced reverberation gain determiner as shown in FIG. 4;

FIG. 7 shows schematically an example FDN reverberator as shown in FIG. 3 according to some embodiments;

FIG. 8 shows a flow diagram of the operations of the determination of the reverberation ratio parameters according to some embodiments;

FIG. 9 shows schematically an example apparatus with transmission and/or storage within which some embodiments can be implemented; and

FIG. 10 shows an example device suitable for implementing the apparatus shown in previous figures.

### EMBODIMENTS OF THE APPLICATION

The following describes in further detail suitable apparatus and possible mechanisms for parameterizing and rendering audio scenes with reverberation.

As discussed above reverberation can be rendered using, e.g., a Feedback-Delay-Network (FDN) reverberator with a suitable tuning of delay line lengths. An FDN allows to control the reverberation times (RT60) and the energies of different frequency bands individually. Thus, it can be used to render the reverberation based on the characteristics of the room or modelled space. The reverberation times and the energies of the different frequencies are affected by the frequency-dependent absorption characteristics of the room.

As described above the reverberation spectrum or level can be controlled using a diffuse-to-direct ratio, which describes the ratio of the energy (or level) of reverberant sound energy to the direct sound energy (or the total emitted energy of a sound source). In ISO/IEC JTC1/SC29/WG6 N00054 MPEG-I Immersive Audio Encoder Input Format, the input to the encoder is provided as DDR value which indicates the ratio of the diffuse (reverberant) sound energy to the total emitted energy of a sound source. Another well-known measure is the RDR which refers to reverberant-to-direct ratio and which can be measured from an impulse response. The relation between these two, described in ISO/IEC JTC1/SC29/WG6 N0083 MPEG-I Immersive Audio CfP Supplemental Information, Recommendations and Clarifications, Version 1, is that

$$10 * log 10 ( DDR ) = 10 * log 10 ( RDR ) - 41 dB .$$

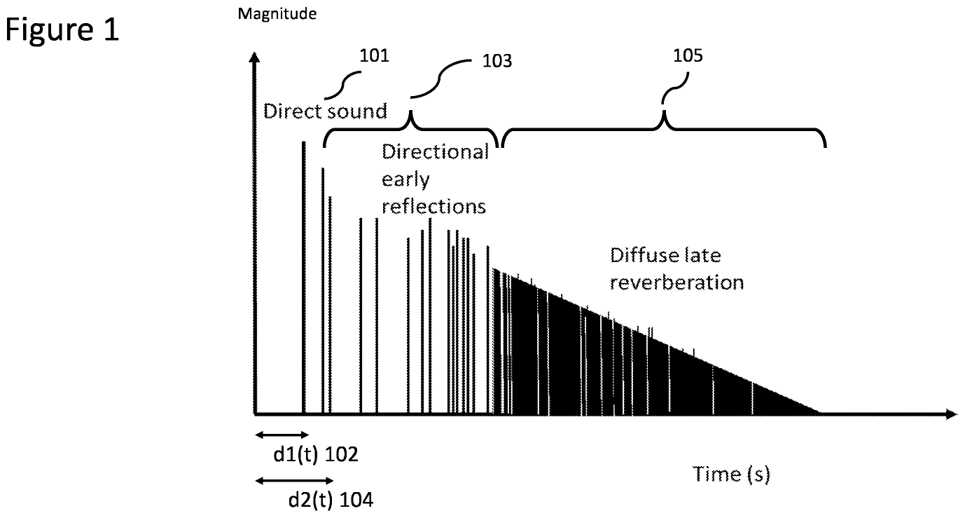

Referring to FIG. 1, the RDR can be calculated by
summing the squares of the sample values of the diffuse late reverberation portion 105
summing the squares of the sample values of the direct sound portion 101
calculating the ratio of these two sums to give the RDR.

The logarithmic RDR can be obtained as 10*log 10(RDR).

There are also models which enable calculation of RDR or DDR values from other acoustic parameters such as RT60 and room dimensions if an impulse response is not available.

To derive the relationship between RT60 and DDR, the derivation can be started from the diffuse approximation of the Critical Distance (CD):

$$CD = sqrt ( ( gamma * A ) / ( 16 * pi ) )$$

with gamma the degree of directivity of the source and A the equivalent absorption surface of the acoustic environment.

If the RDR is expressed on a linear energy scale, then at a distance d from an omnidirectional point source we have the relationship:

$$RDR = ( d / CD ) \hat{} 2$$

because the energy of the direct sound of the omnidirectional point source varies with the square of the distance and the RDR should be equal to 1 at d=CD (by definition).

Inserting the CD value into the RDR equation provides:

$$RDR = d \hat{} 2 * ( ( 16 * pi ) / ( gamma * A ) )$$

As RDR is defined to be measured at 1 meter distance from an omnidirectional point source (gamma=1), this can be simplified to:

$$RDR = ( 16 * pi ) / A$$

Finally, using Sabine's well known relationship that RT60 is approximately equal to (V/6A), the RDR value can be represented as:

$$RDR = 302 * ( RT 60 / V )$$

In logarithmic terms this is:

$$RDR = 10 log 10 ( RT 60 / V ) + 25 ( dB )$$

In order to obtain the DDR value the 41 dB is subtracted.

The above provides a linear relationship between RDR and RT60. This approximation is valid for not too small rooms with not too much absorption but at least it enables to obtain a plausible estimate of RDR if no value is available.

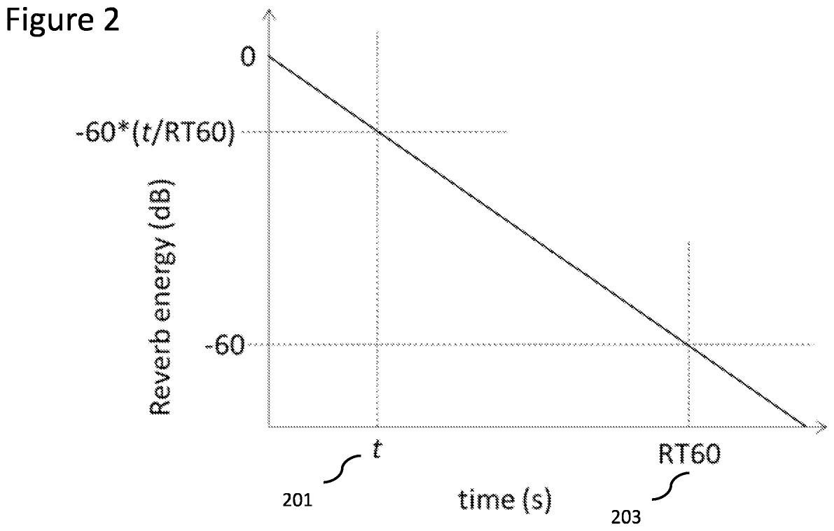

When the rendering of the diffuse reverberation starts at predelay=t, the approximation is modified by removing the part of the diffuse energy before time t. This leads to a reduction of the resulting RDR value by: −60*(t/RT60) dB. This for example is shown in FIG. 2 wherein at predelay=t 201 the reverberation energy is −60*(t/RT60) dB and at RT60 time 203 the reverberation energy is −60 db. Thus FIG. 2 shows the energy decay curve for a perfectly diffuse field.

To compensate for this aspect the formula becomes: RDR=10*log 10(RT60/V)−60*(t/RT60)+25, with t the starting time of the RDR calculation (i.e. the pre-delay value used).

Although there is a definition of input reverberation energy ratios (DDR) that are to be used to adjust the late reverberation level for VR acoustic environments (virtual rooms) or real listening spaces in AR, there are some practical problems observed during practical implementations.

For example, one practical problem is what DDR values to use if no DDR values are provided as an input. Providing DDR values as an input is optional according to the MPEG-I encoder input format N00054 and the MPEG-I listening-space-description format (LSDF) ISO/IEC JTC1/SC29/WG6 N0055. There are theoretical approximations that can be used for deriving DDR values based on RT60 and room dimensions, but they only provide rough estimates of suitable reverberation energy.

Another practical problem is that, especially from measured impulse responses, the calculation of DDR or RDR values provides varying results. This is because, for example, the noise floor level where the energy summation of the late part is stopped has no unambiguous definition, or because the starting point of the late part energy measurement does not have an unambigious definition. In MPEG-I [see N00083], it has been agreed that late part energy measurement starts at the predelay, which is in MPEG-I defined to be equal to:

$${t}_{predelay} = 4 * \frac{{d}_{longest}}{c} ,$$

with c=343 m/s, the speed of sound, and d_{longest} is the largest axis of the bounding volume (in m). However, even with this definition there are some implementation challenges. For example, if a digital reverberator such as the FDN is used to render diffuse late reverberation starting from such a predelay value, the output audio does not sound plausible unless a separate early reflection module is used to fill in the gap between the direct sound and the late diffuse reverberation. Furthermore, because high order early reflections are computationally heavy to render, implementations use shorter predelay values when rendering the late reverberation using a practical digital reverberator such as a feedback-delay-network (FDN). This can create the problem that the input DDR values, measured at t_{predelay}, do not take into account the different predelay used when rendering the reverberation with a reverberator.

A further issue in practical implementations is that in the case of VR content creation or AR listening-space-content creation, the DDR values which are part of acoustic environment data (can also be referred as reverberation or room parameters) are provided by different content creators, which may have their own preferences regarding late reverberation level and/or tools for measuring these values. Therefore, there is a need to enable the content creator to adjust the late reverberation level so that it matches their own preferences across typical range of DDR values provided as an input to the system (encoder or renderer). In case of AR scenes, the estimation of DDR in real world scenarios can be challenging. Estimation of DDR is required for scenarios where only RT60 and listening space dimensions are available.

Therefore, there is a need to be able to adjust the input DDR or RDR values to different predelay values used during rendering. Furthermore, there is a need to enable a mechanism to adjust the input DDR or RDR values to a range which sounds more plausible, even for scenes where the DDR has not been specified by the content creator.

The concept as discussed in the embodiments described in further detail herein relates to reproduction of late reverberation where apparatus and methods are proposed that enables rendering late reverberation based on input reverberation and ratio parameters to match the late reverberation level to frequency dependent energy ratio characteristics. This can in some embodiments be achieved by obtaining information on reverberation ratio parameters (or just reverberation parameters), then based on the information, obtaining at least one reverberation ratio, and obtaining an adjustment value to be applied to the at least one reverberation ratio. Furthermore, in some embodiments the apparatus and methods are configured to apply the adjustment value to the at least one reverberation ratio to obtain an adjusted reverberation ratio. In some embodiments the apparatus comprises a filter and method for designing a filter to control late reverberation ratio using the adjusted reverberation ratio. Then the embodiments comprise rendering late reverberation while applying the filter to adjust the rendered reverberation energy or level (and audio signal(s) and room-related parameters, such as frequency-dependent reverberation times).

In some embodiments, the information on reverberation ratio parameters indicates whether to use an input reverberation ratio or one calculated from an approximation based on other reverberation parameters such as RT60 times and room (enclosure) volume. For example in some embodiments the reverberation energy ratio handling parameter can define how the DDR parameter value is to be adjusted or obtained if situations where no DDR parameter value has been provided.

In some embodiments, the adjustment value is a decibel offset to the at least one reverberation ratio.

In some embodiments, the input to reverberation rendering also contains a first predelay value and the correction value is obtained from an approximation of DDR values based on other room parameters such as RT60 times and room volume such that the correction value can be used to approximate the DDR value at second predelay value different from the first predelay value.

In some embodiments, the correction value contains a description of how to obtain an approximation of the DDR values based on other reverberation parameters such as RT60 times and the adjustment to be applied to such an approximation.

Thus in some embodiments rather than using input late reverberation energy ratio parameters the method is configured to generate input late reverberation level parameters. Furthermore rather than late reverberation energy ratio values the late reverberation level can be used. In some embodiments instead of diffuse-to-total ratio values the apparatus and methods are configured to use reverberant-to-direct ratio, measured as level or energy. Furthermore instead of diffuse-to-total ratio or reverberant-to-direct ratio the embodiments are configured to use their inverses, that is, total-to-diffuse ratio or direct-to-reverberant ratio.

MPEG-I Audio Phase 2 will normatively standardize the bitstream and the renderer processing. There will also be an encoder reference implementation which can be modified later on providing that the output bitstream follows the normative specification. This would therefore permit the codec to improve after the standard has been finalized with novel encoder implementations.

In some embodiments, the portions that could be implemented in different parts of the MPEG-I standard are as follows:

The normative bitstream shall contain the (frequency-dependent) reverberation energy adjustment data and reverberator parameters described using the syntax described here.

The normative renderer shall decode the bitstream to obtain frequency-dependent reverberation ratio adjustment data and reverberator parameters, obtain the adjusted reverberation ratio parameters, design a reverberation ratio control filter using the adjusted parameters, initialize processing components for reverberation rendering using the reverberation parameters, and perform reverberation rendering using the initialized processing components.

Thus for example for VR rendering, reverberator parameters are derived in the encoder and sent in the bitstream. For AR rendering, in some embodiments the reverberator parameters are derived in the renderer based on a listening space description format (LSDF) file or corresponding representation.

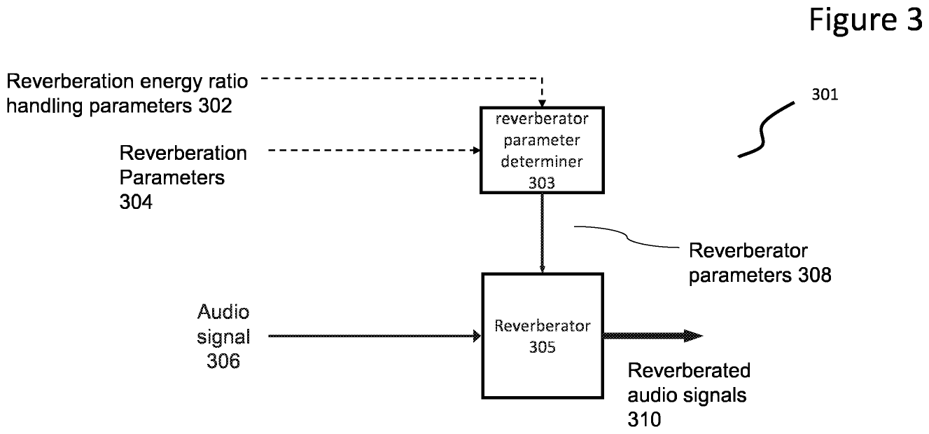

Thus, in some embodiments, there can be an apparatus for providing spatial rendering for room acoustics, the apparatus comprising means configured to adjust a late reverberation level to a frequency dependent energy characteristic at least based on an input reverberation handling parameter and at least one reverberation parameter so as to render late reverberation. The late reverberation level, frequency dependent energy characteristic, input reverberation handling parameter and at least one reverberation parameter are described in the following embodiments. FIG. 3 shows a schematic view of example diffuse-to-direct ratio (DDR) influenced (or DDR based) reverberator apparatus 301 configured to implement some embodiments.

The input to the apparatus 301 comprises reverberation energy ratio handling parameters 302, audio signal 306, and reverberation parameters 304.

An output from the apparatus 301 comprises reverberated audio signals 310 sᵣₑᵥ(j,t) (where j is the output audio channel index). The output reverberated audio signals may in some embodiments be rendered for a multichannel loudspeaker setup (such as 7.1+4). These signals can also be binauralized with head-related-transfer-function (HRTF) filtering for binaural reproduction to headphones).

In some embodiments the apparatus comprises a reverberation parameter determiner 303. The reverberation parameter determiner 303 in some embodiments is configured to obtain reverberation parameters 304. In some embodiments the example, the reverberation parameters 304 are in the form of enclosing room geometry, reverberation times RT60(k) and diffuse-to-total ratios DDRᵢₙ(k) for k frequencies. Note that diffuse-to-total radio can sometimes be referred as diffuse-to-direct ratio, see N00054.

The reverberator parameter determiner 303 in some embodiments is further configured to obtain reverberation energy ratio handling parameters 302. The reverberation energy ratio handling parameters 302 describe how the DDRᵢₙ(k) is to be adjusted (if DDRᵢₙ(k) is provided) or obtained if no DDRᵢₙ(k) has been provided.

The reverberator parameter determiner 303 in some embodiments is configured to determine the reverberator parameters 308 which can be used to configure or initialize a suitable reverberator 305 implementation.

In some embodiments the apparatus 301 comprises a reverberator 305. The reverberator 305 in some embodiments is configured to obtain the audio signal 306 sᵢₙ(t) (where t is time). Furthermore in some embodiments the reverberator is initialized or configured based on the reverberator parameters 308 obtained from the reverberator parameter determiner 303. In some embodiments the reverberator 305 is a Feedback-delay-network (FDN) reverberator which is configured by the reverberator parameters and when applied to the audio signal 306 is able to generate (or reproduce) reverberated audio signals 310. The resulting reverberated audio signals sᵣₑᵥ(j,t) (where j is the output audio channel index) 310 as indicated above may then be rendered for a multichannel loudspeaker setup (such as 7.1+4) or other suitable format output.

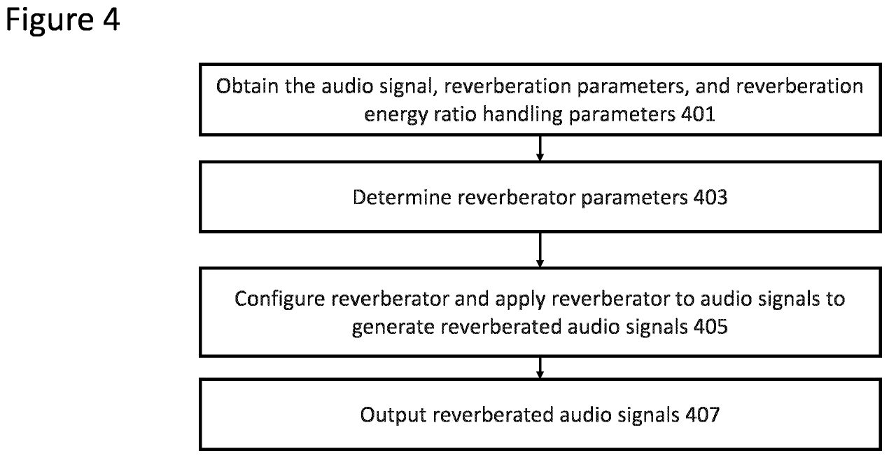

With respect to FIG. 4 is shown a flow diagram showing the operations of the example DDR-influenced reverberator 301 shown in FIG. 3.

The first operation can be obtaining the audio signal, reverberation parameters and reverberation energy ratio handling parameters as shown in FIG. 4 by step 401.

Then the reverberator parameters are determined based on the reverberation parameters, and reverberation energy ratio handling parameters as shown in FIG. 4 by step 403.

Having determined the (DDR-influenced) reverberator parameters then the reverberator parameters are used to configured to reverberator and the reverberator is used to generate the reverberated audio signals as shown in FIG. 4 by step 405.

Then the reverberated audio signals are output as shown in FIG. 4 by step 407.

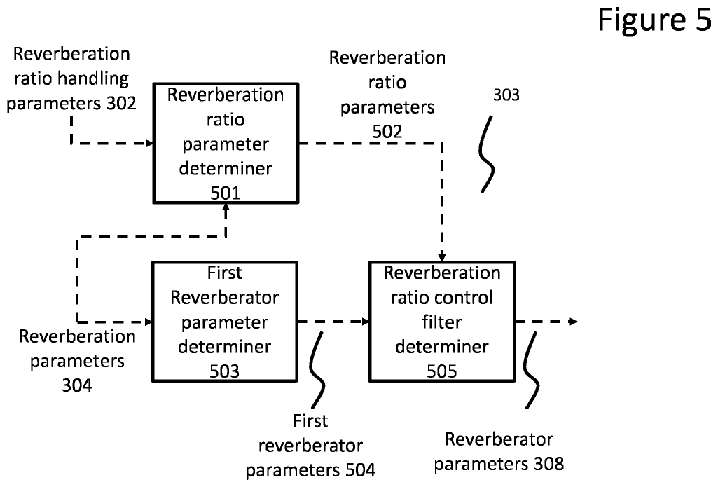

FIG. 5 shows schematically an example reverberator parameter determiner 303 in further detail. As shown in FIG. 3 the inputs to the reverberator parameter determiner can be the reverberation parameters 304 and reverberation ratio handling parameter 302. The reverberation parameters 304 can in some embodiments be the RT60 times, optional DDR values, and dimensions of the enclosure within which the reverberation has the characteristics determined by the reverberation parameters. The dimensions of the enclosure for example can be provided as a mesh or as a bounding box.

In some embodiments the reverberator parameter determiner comprises a reverberation ratio parameter determiner 501, a first reverberator parameter determiner 503 and a reverberation ratio control filter determiner 505.

The first reverberator parameter determiner 503 is configured to obtain the reverberation parameters 304 and generate a first reverberator parameter set, or first reverberator parameters 504.

The reverberation ratio parameter determiner 501 is configured to obtain the reverberation parameters 304 and the reverberation ratio handling parameters 302 and generate reverberation ratio parameters 502.

Furthermore the reverberator parameter determiner 303 comprises a reverberation ratio control filter determiner 505. The reverberation ratio control filter determiner is configured to obtain the reverberation ratio parameters 502 and the a first reverberator parameter set, or first reverberator parameters 504 and generate suitable reverberator parameters 308 which can be used to configured the reverberator.

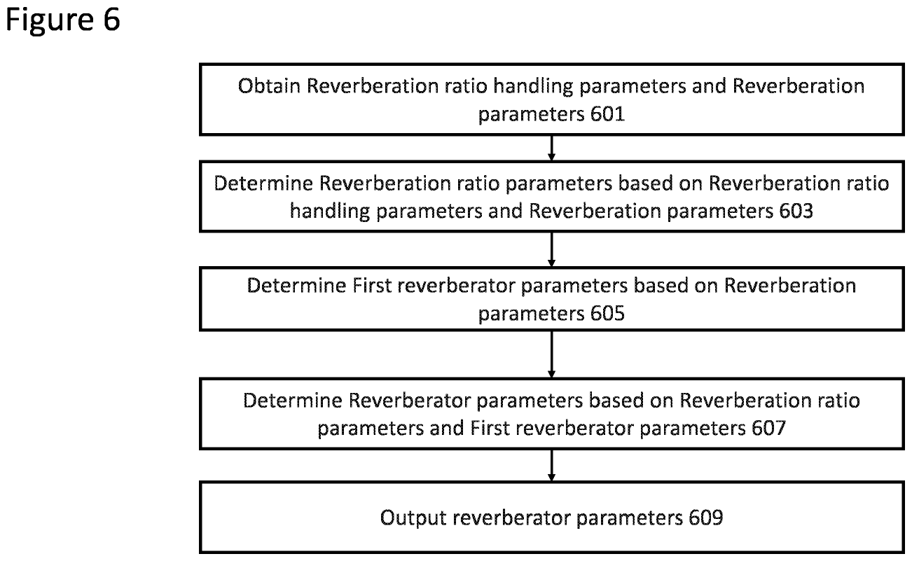

With respect to FIG. 6 is shown a flow diagram of the operations of the reverberator parameter determiner 303 as shown in FIG. 5.

In some embodiments the method comprises obtaining reverberation ratio handling parameters and reverberation parameters as shown in FIG. 6 by step 601.

Then in some embodiments the method comprises determining reverberation ratio parameters based on reverberation ratio handling parameters and Reverberation parameters as shown in FIG. 6 by step 603.

Also the method comprises determining first reverberator parameters based on reverberation parameters as shown in FIG. 6 by step 605.

Having determined the first reverberator parameters and reverberation ratio parameters then the reverberator parameters are determined based on the first reverberator parameters and reverberation ratio parameters as shown in FIG. 6 by step 607.

Then the reverberator parameters are output as shown in FIG. 6 by step 609.

The reverberator parameters are configured such that, when initialized with the reverberator parameters, the reverberator produces an output with the desired RT60 times. In the following example the reverberator implementation is a FDN and as such the reverberator parameter determiner is configured to determine parameters for the FDN such that its output has the desired RT60 times.

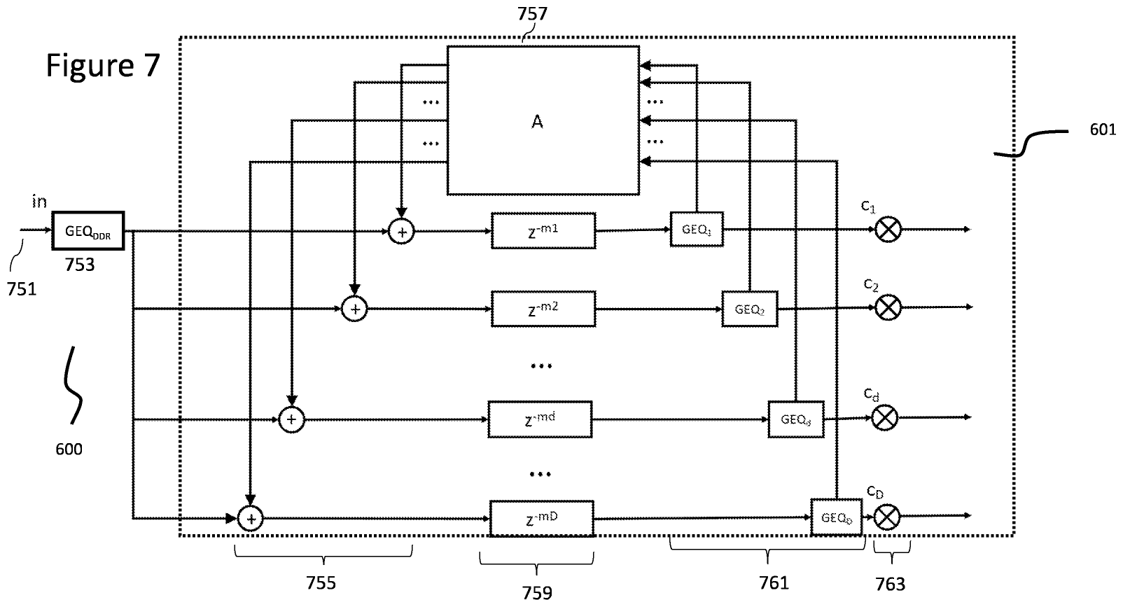

With respect to FIG. 7 there is shown an example FDN reverberator which can be used to produce D uncorrelated output audio signals 765. The reverberator comprises an input 751 and DDR filter GEQ_{DDR} 753 and uses a network of delays 759, feedback elements (shown as attenuation filters 761, feedback matrix 757 and combiners 755) and output gain 763 to generate a very dense impulse response for the late part. Each output signal can be rendered at a certain spatial position around the listener for an enveloping reverberation perception. Such rendering can be done with physical loudspeaker or by spatializing the output signals at distinct spatial positions with HRTF filtering for headphone reproduction.

The parameters of the FDN reverberator 701 can be configured or adjusted so that it produces reverberation having characteristics matching the input reverberation parameters and reverberation ratio handling parameters. For the FDN reverberator 701 the parameters contain the coefficients of each attenuation filter GEQd 761, feedback matrix coefficients A 757, and lengths ma for D delay lines 759. In this example embodiment, each attenuation filter GEQd 761 is a graphic EQ filter using M biquad IIR band filters.

With octave bands M=10, thus, the parameters of each graphic EQ comprise the feedforward b and feedback a coefficients for 10 biquad IIR filters, the gains for biquad band filters, and the overall gain.

The number of delay lines D can be adjusted depending on quality requirements and the desired tradeoff between reverberation quality and computational complexity. In an embodiment, an efficient implementation with D=15 delay lines is used. This makes it possible to define the feedback matrix coefficients A 757 as proposed by Rocchesso: Maximally Diffusive Yet Efficient Feedback Delay Networks for Artificial Reverberation, IEEE Signal Processing Letters, Vol. 4. No. 9, September 1997 in terms of a Galois sequence facilitating efficient implementation.

A length m_{d} for the delay line d 759 can be determined based on virtual room dimensions. Here, we use the dimensions of the enclosure. For example, a shoebox shaped room can be defined with dimensions xDim, yDim, zDim. If the room is not shaped as a shoebox then a shoebox can be fit inside the room and the dimensions of the fitted shoebox can be utilized for the delay line lengths. Alternatively, the dimensions can be obtained as three longest dimensions in the non-shoebox shaped room, or other suitable method. Such dimensions can also be obtained from a mesh if the bounding box is provided as a mesh. The dimensions can further be converted to modified dimensions of a virtual room or enclosure having the same volume as the input room or enclosure. For example, the ratios 1, 1.3, and 1.9 can be used for the converted virtual room dimensions.

The delays 759 can in some embodiments be set proportionally to standing wave resonance frequencies in the virtual room or physical room. The delay line lengths ma can further be made mutually prime.

The attenuation filter 761 coefficients in the delay lines are adjusted so that a desired amount in decibels of attenuation happens at each signal recirculation through the delay line so that the desired RT60(f) time is obtained. This is implemented in some embodiments in a frequency specific manner to ensure the appropriate rate of decay of signal energy at specified frequencies f.

The input to an encoder can provide the desired RT60 times per specified frequencies f denoted as RT60(f). For a frequency f, the desired attenuation per signal sample is calculated as attenuationPerSample(f)=−60/(samplingRate*RT60(f)). The attenuation in decibels for a delay line of length m_{d} is then attenuationDb(f)=m_{d}*attenuationPerSample(f).

The attenuation filters 761 can in some embodiments implemented as cascade graphic equalizer filters as described in V. Välimäki and J. Liski, “Accurate cascade graphic equalizer,” IEEE Signal Process. Lett., vol. 24, no. 2, pp. 176-180, February 2017 for each delay line. The design procedure outlined in the above reference takes as input a set of command gains at octave bands. There are also methods for a similar graphic EQ structure which can support third octave bands, increasing the number of biquad filters to 31 and providing better match for detailed target responses such as described in Rämö, J, Liski, J & Välimäki, V 2020, ‘Third-octave and Bark graphic-equalizer design with symmetric band filters’, Applied Sciences (Switzerland), vol. 10, no. 4, 1222. https://doi.org/10.3390/app10041222. The above routines can be referred as the ACGE design routines.

In some embodiments the output from first reverberator parameter determiner 503, the first reverberator parameters 504 comprise delay line lengths and the delay line attenuation filter parameters.

The reverberation ratio parameters can in some embodiments refer to the diffuse-to-total energy ratio (DDR) or reverberant-to-direct ratio (RDR) or other equivalent representation. The ratio parameters can be equivalently represented on a linear scale or logarithmic scale.

In some embodiments the reverberation ratio parameter determiner 501 in some embodiments is configured to obtain or determine reverberation energy. In some embodiments this can be implemented as receiving the RT60(f) values, the dimensions of the acoustic enclosure, and optionally diffuse-to-total ratio DDR(f) values.

Furthermore the reverberation ratio parameter determiner can be configured, as discussed above, to obtain or receive as an input the reverberation ratio handling parameters 302. The reverberation ratio handling parameters 302 in some embodiments can be constants defined in software code or received as an input where the reverberation ratio parameter determiner is executed on an encoder device for VR use cases or signalled in bitstream when executed on a renderer device for AR use cases.

In some embodiments the reverberation ratio handling parameters can comprise the following:
IsdfSpeedOfSound—speed of sound in m/s for calculating the EIF predelay.
IsdfTheoreticalRdrToActualRdrDb—adjustment in decibels to be applied to RDR values calculated based on a linear approximation of RDR values based on RT60 data. This adjustment can either be increased or decreased by the specified value, which can in some embodiments be decided by the renderer during run-time. In some implementation scenarios, the adjustment shall be specified only to decrease the RDR values determined based on RT60 data whereas in other cases it shall be specified to increase the RDR values determined based on RT60 data. In some embodiments, as the theoretical model provides an upper bound for DDR values, only reduction of the DDR value is allowed.
IsdfRdrToActualRdrDb—adjustment in decibels to be applied to RDR values received as input.
overrideLsdfDdr—toggle overriding LSDR DDR values on/off.

In some embodiments these values can be adjusted by a content creator or an encoder device automatically. In some embodiments default values for the parameters can be:

$$\begin{matrix}\begin{matrix}lsdfSpeedOfSound = 343. \\ lsdfTheoreticalRdrToActualRdrDb = - 11\end{matrix} \\ IsdfRdrToActualRdrDb = - 4 \\ overrideLsdfDrd = true\end{matrix}$$

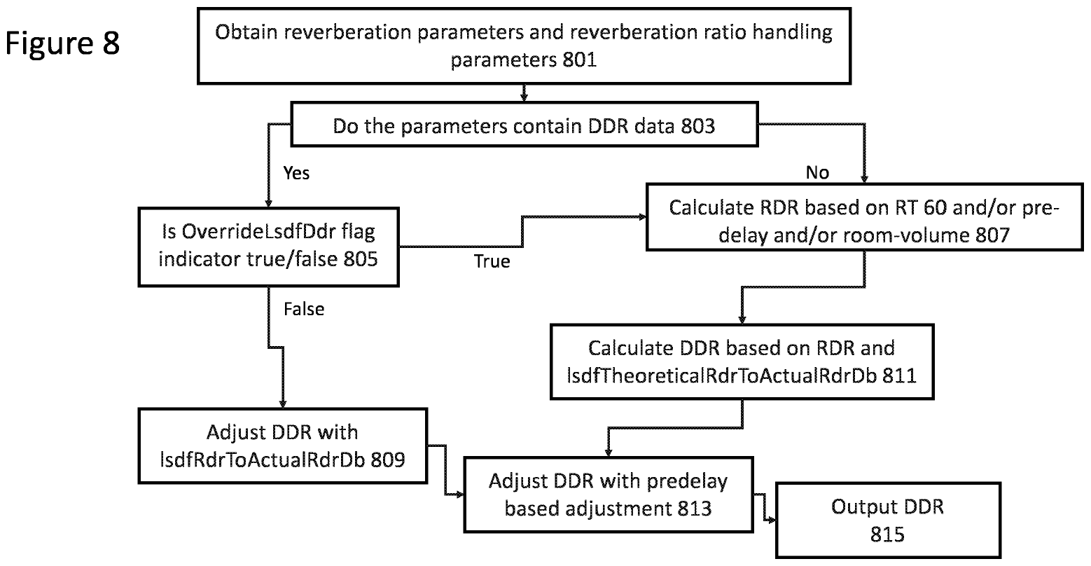

With respect to FIG. 8 there is shown a flow diagram of a method implemented within the example reverberation ratio parameter determiner 501.

The first operation is obtaining or otherwise determining the reverberation parameters and reverberation ratio handling parameters as shown in FIG. 8 by step 801.

Then the next operation is one in which there is a determination as to whether the parameters contain DDR data as shown in FIG. 8 by step 803. In other words the method checks if the input (EIF or LSDF) contains DDR values.

Where the DDR data is determined to exist then the method comprises a further check where it is determined whether there is a DDR value override flag or other indicator active (In other words whether OverrideLsdfDdr is true). The override check is shown in FIG. 8 by step 805.

In some embodiments where there is an active override or there are no DDR values, the embodiments calculate DDR values based on RT60 values using a linear approximation based on RT60, predelay, and room volume. This is shown in FIG. 8 by step 807 by an initial operation of generating a RDR value. Thus for example the RDR values can be determined as:

$$RDR log ( k ) = 10 * log 10 ( RT 60 ( k ) / V ) - 60 * ( {t}_{predelay} / RT 60 ( k ) ) + 25 ,$$

with t_{predelay} the starting time of the RDR calculation (i.e., the pre-delay value used) and V the room volume.

In some embodiments a bounding box volume is calculated as

$$\begin{matrix}boundingBoxWidth = boundingBox . xMax - boundingBox . xMin \\ boundingBoxHeight = boundingBox . yMax - boundingBox . yMin \\ boundingBoxDepth = boundingBox . zMax - boundingBox . zMin\end{matrix}$$

where xMax and xMin refer to the maximum and minimum value of the Cartesian x coordinates of the bounding box vertices, respectively. Similarly, max and min values can be obtained for the y and z coordinates. Note that allocation of width, height, and depth to the different Cartesian axes can be changed.

In some embodiments the room volume V can be calculated as

$$V = boundingBoxWidth * boundingBoxHeight * boundingBoxDepth$$

The longest room dimension d_{longest} is obtained as
d_{longest}=max (boundingBoxWidth, boundingBoxHeight, boundingBoxDepth) max denotes maximum.
eifPredelay is calculated as

$${t}_{predelay} = 4 * \frac{{d}_{longest}}{lsdfSpeedOfSound}$$

In some embodiment, other determination approximation equations can be employed. For example, instead of using an approximation based on linear decay of reverberation energy, the decay can be approximated with higher order polynomials, such as second or third order. Furthermore in some embodiments the bitstream can contain information on which approximation equation should be employed by the renderer when approximating the RDR values, or which approximation equation was used by the encoder device in obtaining the signalled RDR values. As an example, the bitstream can contain the order of the polynomial to be used (or which was used) in the approximation, such as 1 for first order, 2 for second order, 3 for third order, and so on.

In some embodiments there is a fixed or predetermined set of known equations that can be used to approximate the RDR values based on other room parameters, and an index such a known set of equations can be included in the bitstream as an indicator to select the suitable approximation based on content creator intent.

In some embodiments the DDR values are obtained or calculated based on the RDR values and the IsdfTheoreticalRdrToActualRdrDb value as shown in FIG. 8 by step 811. Thus for example the logarithmic DDR values are calculated as here

$$DDR log ( k ) = RDR log ( k ) - 41 dB + lsdfTheoreticalRdrToActualRdrDb$$

This can be followed by adjustment with predelay-based adjustment, which is described in the following.

In some embodiments the logarithmic DDR values can optionally be converted to linear DDR values as

$$DDR ( k ) = {10}^{( DDR log ( k ) / 10 )}$$

Thus in some embodiments, the conversion from RDR to DDR is implemented by subtracting 41 dB (as agreed for the MPEG-I encoder input format DDR definition, see N0083). The adjustment with IsdfTheoreticalRdrToActualRdrDb provides a convenient mechanism for the content creator to adjust the level from the RDR values provided by the theoretical approximation to values to be used by the filter design routines. Such adjustment is necessary as usually the RDR values from the approximation, if used directly for adjusting the reverb level, result in perceptually too high levels of reverberation.

Where it is determined that the parameters comprise DDR values and they are not to be overridden (in other words the input contains DDR values and overrideLsdfDdr is false), then the method is configured to use the DDR values from the input. The offset IsdfRdrToActualRdrDb can be applied to the input DDR values before designing the DDR control filter. This enables the content creator to adjust the level of reverberation energy to a suitable level. For example, during the MPEG-I CfP evaluation it has been observed that the DDR values provided by listening test laboratories in their LSDF files are rather high, and the output would perceptually sound too reverberant where the values were used directly. With the level adjustment parameter, the embodiments can implement an adjustment to the values to lower them to a suitable level. The content creator can set the offset value to such a level that the reverberation level sounds plausible across a range of LSDF input files.

The logarithmic DDR values after adjustment are obtained as

$$DDR log ( k ) = 10 {log}_{10} ( {DDR}_{in} ( k ) ) + lsdfRdrToActualRdrDb$$

The logarithmic DDRlog values can then be optionally converted to linear values DDR(k) for further processing.

The adjustment of the DDR using the IsdfRdrToActualRdrDb parameter is shown in FIG. 8 by step 809.

In some embodiments the theoretical approximation is used to adjust the DDRᵢₙ(k) values determined at a first predelay (e.g. the EIF predelay=t_{predelay}) to a second predelay=t₂. This second predelay t₂ can be such a predelay which is used for rendering the reverberation with the Reverberator.

The input DDR values DDRlog were obtained at EIF-predelay t_{predelay}. Using the theoretical model, the method can calculate DDRlog data at the second predelay=t₂.

With the adjustment the DDRlog are obtained as

$$DDR log ( k ) = 10 {log}_{10} ( {DDR}_{in} ( k ) ) + 60. * ( predelayDifference / RT 60 ( k ) )$$

where predelayDifference=t_{predelay}−t₂ and the term+60.0*(predelayDifference/RT60(k)) is the adjustment.

This adjustment allows approximating the DDR values when reverberation is to be rendered starting from a predelay different from the predelay at which the values are obtained, and to approximate the adjustment that needs to be done to the DDR values.

The adjustment of the DDR with predelay based adjustment is shown in FIG. 8 by step 813.

In some embodiments both the predelay-based DDR adjustment and adjustment with IsdfRdrToActualRdrDb can be applied or just one of them can be applied.

The above DDR data can be obtained at a set of frequencies k which are the same frequencies for which we have obtained the RT60(k).

The DDR is then output as shown in FIG. 8 by step 815 where the values DDR(k) are output.

The reverberation ratio control filter determiner 505 is configured to design the GEQ_{DDR} filter such that, when the filter is applied to the input data of the FDN reverberator, the output reverberation will have the desired energy ratio defined by the DDR(k). The input to the design procedure is the DDR values DDR(k).

The values DDR(k) in some embodiments are mapped to a set of frequency bands b, which can be, e.g., either octave or third octave bands. Other choices such as Bark bands or frequency bands with linearly-spaced centre frequencies are also possible in some embodiments. This results in the frequency mapped DDR values DDR(b).

When receiving linear DDR values DDR(b), they can be converted to linear RDR values as

$$RDR ( b ) = DDR ( b ) * {10}^{( 41 / 10 )}$$

The GEQ_{DDR} matches the reverberator spectrum energy to the target spectrum energy. In order to do this, the filter determiner is configured to obtain an estimate of the RDR of the reverberator output and the target RDR. The RDR of the reverberator output can be obtained by rendering a unit impulse through the reverberator using the first reverberator parameters and measuring the energy of the reverberator output and energy of the unit impulse and calculating the ratio of these energies.

In some embodiments the filter determiner is configured to create a unity impulse input where the first sample value is 1 and the length of the zero tail is ‘long enough’. In practice, the determiner is configured to adjust the length of the zero tail to equal max (RT60(b)) plus the t_{predelay} in samples. The monophonic output of the reverberator is of interest so the reverberator is configured to sum over the delay lines j to obtain the reverberator output sᵣₑᵥ(t) as a function of time t.

In some embodiment a long FFT (of length NFFT) is calculated over sᵣₑᵥ(t) and its absolute value is obtained as

$$FFA ( kk ) = abs ( FFT ( {s}_{rev} ( t ) )$$

Here, kk are the FFT bin indices. Furthermore is obtained the positive half spectral energy density as

$$S ( kk ) = 1 / NFFT * {FFA ( kk )}^{2}$$

where the energy from the negative frequency indices kk is added into the corresponding positive frequency indices kk.

The energy of a unit impulse can be calculated with the help of the FFT as above or obtained analytically. (The energy of the unit impulse can be denoted as Su(kk)).

Then band energies are calculated of both the positive half spectral energy density of the reverberator S(kk) and the positive half spectral energy density of the unit impulse Su(kk). Band energies can be calculated as

$$S ( b ) = {\sum }_{kk = {b}_{low}}^{{b}_{high}} S ( kk )$$

where b_{low} and b_{high} are the lowest and highest bin index belonging to band b, respectively. The same is done to obtain Su(kk). The band bin indices can be obtained by comparing the frequencies of the bins to the lower and upper frequencies of each band and picking for the summation above those bins which fall in between.

The reproduced RDRᵣₑᵥ(b) of the reverberator output at the frequency band b is obtained as

$${RDR}_{rev} ( b ) = S ( b ) / Su ( b )$$

The target linear magnitude response for GEQ_{DDR} can be obtained as ddrFilterTargetResponse(b)=sqrt(RDR(b))/sqrt(RDRᵣₑᵥ(b))
where RDR(b) is the linear target RDR value mapped to frequency band b. Mapping of input RDR values to frequency bands b can be implemented, for example, by obtaining for each band b the value from the input RDR response RDR(k) at the closest frequency k to the center frequency of band b.

GontrolGain(b)=20*log 10(ddrFilterTargetResponse(b)) is input as the target response for the graphic equalizer design routine in Välimäki, Rämö, “Neurally Controlled Graphic Equalizer”, IEEE/ACM TRANSACTIONS ON AUDIO, SPEECH, AND LANGUAGE PROCESSING, VOL. 27, NO. 12, December 2019 (the control gains). This can be referred as the neurally controlled ACGE routine. In other embodiments, alternative graphic EQ design routines can be used.

In some embodiments, a noise sequence is used as input instead of a unit impulse. In some embodiments, the spectral energy is analyzed using a filterbank of butterworth filters instead of the FFT.

The DDR filter target response (control gains for the graphic EQ design routine) can also be obtained directly in the logarithmic domain as

$$ControlGain ( b ) = 10 {log}_{10} ( RDR ( k ) ) - 10 {log}_{10} ( {RDR}_{rev} ( b ) )$$

In some embodiments when the method is executed on an encoder, the ACGE design routine can be used for octave band filters. When the method is executed on the renderer, the neurally controlled ACGE design routine is used for obtaining the filter parameters.

The first reverberator parameters and the parameters of the Reverberator DDR control filter GEQ_{DDR} together form the complete reverberator parameters 308.

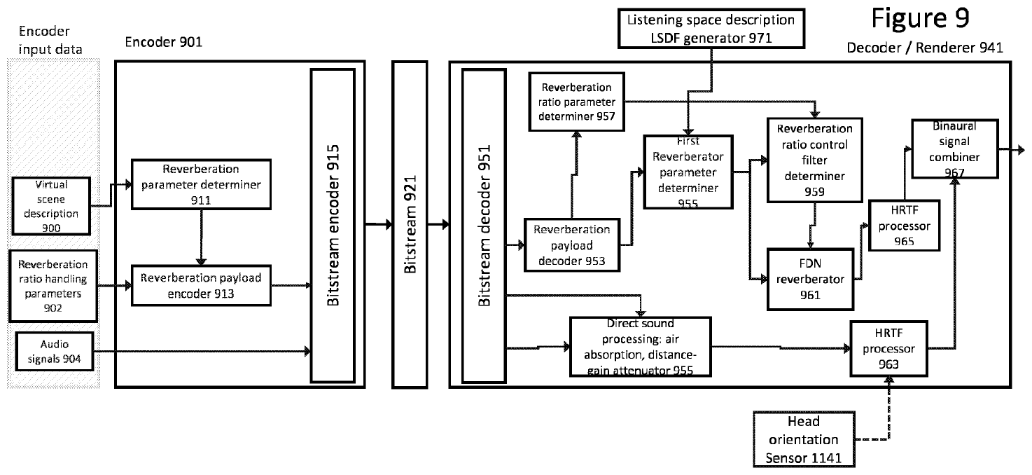

FIG. 9 shows schematically an example system where the embodiments of the invention are implemented in an encoder device 901 which performs part of the functionality; writes data into a bitstream 921 and transmits that for a renderer device 941, which decodes the bitstream, performs reverberator processing according to the embodiments and outputs audio for headphone listening.

The encoder side 901 of FIG. 9 can be performed on content creator computers and/or network server computers. The output of the encoder is the bitstream 921 which is made available for downloading or streaming. The decoder/renderer 941 functionality runs on end-user-device, which can be a mobile device, personal computer, sound bar, tablet computer, car media system, home HiFi or theatre system, head mounted display for AR or VR, smart watch, or any suitable system for audio consumption.

The encoder 901 is configured to receive the virtual scene description 900, the reverberation ratio handling parameters 902 and the audio signals 904. The virtual scene description 900 can be provided in the MPEG-I Encoder Input Format (EIF) or in other suitable format. Generally, the virtual scene description contains an acoustically relevant description of the contents of the virtual scene, and contains, for example, the scene geometry as a mesh, acoustic materials, acoustic environments with reverberation parameters, positions of sound sources, and other audio element related parameters such as whether reverberation is to be rendered for an audio element or not. The encoder 901 in some embodiments comprises a reverberation parameter determiner 911 configured to receive the virtual scene description 900 and configured to obtain the reverberation parameters. The reverberation parameters can in an embodiment be obtained from the RT60, DDR, predelay, and region/enclosure parameters of acoustic environments.

The encoder 901 furthermore in some embodiments comprises a reverberation payload encoder 913 configured to obtain the determined reverberation parameters and the reverberation ratio handling parameters and generate reverberation parameters.

The encoder 901 furthermore in some embodiments comprises a bitstream encoder 915 which is configured to receive the output of the reverberation payload encoder 913 and the audio signals 904 and generate the bitstream 921 which can be passed to the bitstream decoder 941. In other words the normative bitstream can be configured to contain the reverberation ratio handling data and reverberator parameters described using the syntax described here. The bitstream 921 in some embodiments can be streamed to end-user devices or made available for download or stored.

The decoder 941 in some embodiments comprises a bitstream decoder 951 configured to decode the bitstream to obtain reverberation ratio handling data and reverberator parameters.

The decoder 941 further can comprise a reverberation payload decoder 953 configured to obtain the encoded reverberation ratio handling data and reverberator parameters and decode these in an opposite or inverse operation to the reverberation payload encoder 913.

The decoder 941, in some embodiments, comprises a reverberation ratio parameter determiner 957 which receives the output of the reverberation payload decoder 953 and generates the reverberation ratio parameters and passes this to the reverberation ratio control filter determiner 959.

In some embodiments the decoder 941 comprises a first reverberation parameter determiner 955 configured to receive the output of the reverberation payload decoder 953 and a listening space description (LSDF) generator 971 output and configured to generate the first reverberation parameters and pass these to the reverberation ratio control filter determiner 959 and the FDN reverberator 961.

Furthermore is shown that the decoder 941 comprises a reverberation ratio control filter determiner 959 which is configured to obtain the first reverberator parameter determiner 955 output and the reverberation ratio parameter determiner 957 output and from this generate the ratio control filter parameters.

The decoder furthermore comprises a FDN reverberator 961 configured by the output of the reverberation ratio control filter determiner 959 and first reverberation parameter determiner 955 and configured to implement a suitable reverberation of the audio signals.

The output of the FDN reverberator 961 is configured to output to a suitable HRTF processor 965.

In some embodiments the decoder 941 comprises a HRTF processor 965 configured to apply a HRTF processing to the late reverberated audio signals to generate a binaural audio signal and output this to a binaural signal combiner 967.

Additionally the decoder/renderer 941 comprises a direct sound processor 955 which is configured to receive the decoded audio signals from the bitstream decoder and configured to implement any direct sound processing such as air absorption and distance-gain attenuation and which can be passed to a HRTF processor 963 which with the head orientation determination (from a suitable sensor 1141) can generate the direct sound component which with the reverberant component from the HRTF processor 965 is passed to a binaural signal combiner 967. The binaural signal combiner 967 is configured to combine the direct and reverberant parts to generate a suitable output (for example for headphone reproduction).

Furthermore in some embodiments the decoder comprises a head orientation determiner 1141 which passes the head orientation information to the HRTF processor 963.

Although not shown, there can be various other audio processing methods applied such as early reflection rendering combined with the proposed methods.

In the example embodiment shown in FIG. 9 the reverberation parameters and reverberation ratio handling parameters are encoded into a bitstream payload referred as Reverberation payload.

MPEG-I Audio Phase 2 will normatively standardize the bitstream and the renderer processing. There will also be an encoder reference implementation, but it can be modified later on as long as the output bitstream follows the normative spec. This allows improving the codec quality also after the standard has been finalized with novel encoder implementations.

In our invention main embodiment, the portions going to different parts of the MPEG-I standard are as follows, referring to FIG. 9:
Encoder reference implementation will contain
   Obtaining the reverberation ratio handling parameters, either as an input to the encoder, from a configuration file, or automatically
   Writing a bitstream description containing the (optional) reverberator parameters and reverberation ratio handling parameters. If there is at least one virtual enclosure with reverberation parameter in the Virtual scene description, then there will be parameters for the corresponding reverberator written into the Reverb payload. Otherwise Reverb payload only carries the reverberation ratio handling parameters.
The normative bitstream shall contain reverberation ratio handling parameters and (optional) reverberator parameters described using the syntax described here. The bitstream shall be streamed to end-user devices or made available for download or stored.
The normative renderer shall decode the bitstream to obtain the reverberation ratio handling parameters and reverberator parameters, determine reverberator parameters and perform adjustment of the reverberation ratio parameters as described in the invention, design the reverberation ratio control filter, initialize processing components to perform reverberation rendering according to the parameters and perform reverberation rendering using the initialized processing components using the presented method.
   For VR rendering, reverberator parameters are derived in the encoder and sent in the bitstream.
   For AR rendering, reverberator parameters are derived in the renderer based on a listening space description format (LSDF) file or corresponding representation.
The complete normative renderer will also obtain other parameters from the bitstream related to room acoustics and sound source properties, and use them to render the direct sound, early reflection, diffraction, sound source spatial extent or width, and other acoustic effects in addition to diffuse late reverberation. The invention presented here focuses on the rendering of the diffuse late reverberation part and in particular how to adjust the diffuse late reverberation spectrum based on reverberation ratio parameters (DDR) and other parameters which describe adjustments to the received reverberation ratio parameters.

The reverberation parameters mapped into digital reverberator parameters with DDR control filter GEQ_{DDR} parameters is described in the following bitstream definition.

| REVERB METADATA | Bits | Mnemonic |
|---|---|---|
| reverbPayloadStruct( ){ | | |
| numberOfSpatialPositions; | 2 | bslbf |
| for(int i=0;i<numberOfSpatialPositions;i++){ | | |
| azimuth; | 9 | tcimsbf |
| elevation; | 9 | tcimsbf |
| } | | |
| numberOfAcousticEnvironments; | 8 | uimsbf |
| for(int i=0;i<numberOfAcousticEnvironments;i++){ | | |
| environmentsId; | 16 | tcimsbf |
| filterParamsStruct( ); | | |
| for(int | | |
| j=0;j<numberOfSpatialPositions;j++){ | | |
| delayLineLength; | 32 | uimsbf |
| filterParamsStruct( ); | | |
| } | | |
| lsdfSpeedOfSound; | 31 | tcimsbf |
| lsdfTheoreticalRdrToActualRdrDb; | 16 | tcimsbf |
| lsdfTheoreticalRdrToActualRdrDb_adjustment_type; | 4 | Uimsbf |
| lsdfRdrToActualRdrDb | 16 | tcimsbf |
| lsdfRdrToActualRdrDb_adjustment_type; | 4 | Uimsbf |
| overrideLsdfDdr | 1 | bslbf |
| } | | |

The semantics of the structure reverbPayloadStruct( ) can be for example:
numberOfSpatialPositions defines the number of output delay line positions for the late reverb payload. This value is defined using an index which corresponds to a specific number of delay lines. The value of the bit string ‘0b00’ signals the renderer to a value of 15 spatial orientations for delay lines. The other three values ‘0b01’, ‘0b10’ and ‘0b11’ are reserved.
azimuth defines azimuth of the delay line with respect to the listener. The range is between −180 to 180 degrees.
elevation defines the elevation of the delay line with respect to the listener. The range is between −90 to 90 degrees.
numberOfAcousticEnvironments defines the number of acoustic environments in the audio scene. The reverbPayloadStruct( ) carries information regarding the one or more acoustic environments which are present in the audio scene at that time. An acoustic environment has certain “Reverberation parameters” such as RT60 times which are used to obtain FDN reverb parameters.
environment Id This value defines the unique identifier of the acoustic environment.
delayLineLength defines the length in units of samples for the graphic equalizer (GEQ) filter used for configuration of the delay line attenuation filter. The lengths of different delay lines corresponding to the same acoustic environment are mutually prime.
filterParamsStruct( ) this structure describes the graphic equalizer cascade filter to configure the attenuation filter for the delay lines. The same structure is also used subsequently to configure the filter for diffuse-to-direct reverberation ratio GEQ_{DDR}. The details of this structure are described in the next table.

The Semantics for handling of LSDF based rendering of reverberation can be as follows:
lsdfSpeedOfSound specifies the speed of sound in units of meters per second to be used for performing the reverb rendering with LSDF.
lsdfTheoreticalRdrToActualRdrDb specifies the adjustment in decibels from the RDR values which are calculated based on a linear approximation of RDR values based on RT60 data. The bitstream signalling of this parameter for AR rendering, indicates the adjustment in decibels from the RDR value obtained from RT60 in the listening space description file (LSDF).
lsdfTheoreticalRdrToActualRdrDb adjustment_type specifies that value equal to ‘00’ the adjustment should decrease in decibels from the RDR values which are calculated based on a linear approximation of RDR values based on RT60 data.

A value equal to 01′ specifies that the adjustment should increase in decibels from the RDR values which are calculated based on a linear approximation of RDR values based on RT60 data.

A value equal to ‘10’ specifies that the adjustment increase or decrease in decibels from the RDR values which are calculated based on a linear approximation of RDR values based on RT60 data is decided by the renderer and not pre decided during scene authoring or content creation.

A value equal to ‘11’ is reserved in this example.

Furthermore, the bitstream signalling of this parameter for AR rendering, indicates the adjustment in decibels from the RDR value obtained from RT60 in the listening space description file (LSDF).
lsdfRdrToActualRdrDb specifies the adjustment in decibels in decibels to be applied to RDR values received as input in the listening space description information (e.g., LSDF). A content creator may adjust this value such that, when rendering is done using a collection of example LSDF files, the output is at a perceptually plausible level. For the CfP renderer evaluation, we adjusted the value such that, across a selection of 7 LSDF files with provided DDR values, the output level of reverberation sounded plausible.
overrideLsdfDdr For value equal to 1, the renderer shall override the DDR value specified in LSDF. For a value equal to 0, the DDR value in LSDF shall be used. The content creator can use this flag to override using the DDR values provided in the LSDF values. Such a choice can be based on, for example, desire to have tighter control of the output reverberation levels without allowing them to be controlled independently from the RT60 data but have them coupled with the input RT60 data with the linear approximation.

The semantics of filterParamsStruct( ) can in some embodiments be:
SOSLength is the length of the each of the second order section filter coefficients.
b1, b2, a1, a2 The filter is configured with coefficients b1, b2, a1 and a2. These are the feedforward and feedback IIR filter coefficients of the second-order section IIR filters.
globalGain specifies the gain factor in decibels for the GEQ.
level DB specifies a sound level offset for each of the delay lines in decibels.

All filterParamsStruct( ) get deserialized into a GEQ object in the renderer.

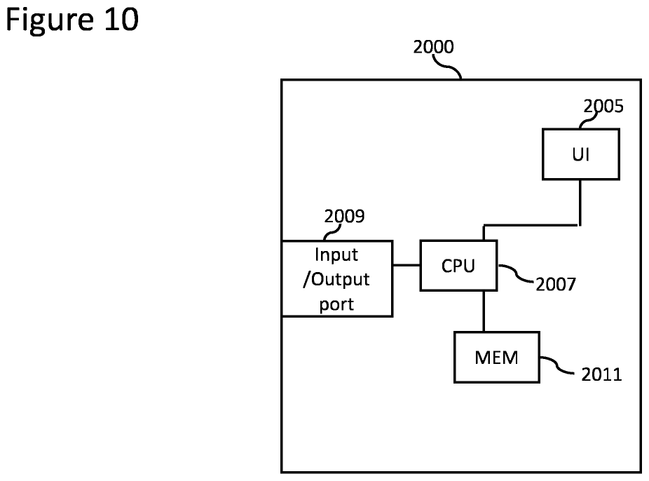

With respect to FIG. 10 an example electronic device which may be used as any of the apparatus parts of the system as described above. The device may be any suitable electronics device or apparatus. For example in some embodiments the device 2000 is a mobile device, user equipment, tablet computer, computer, audio playback apparatus, etc. The device may for example be configured to implement the encoder or the renderer or any functional block as described above.

In some embodiments the device 2000 comprises at least one processor or central processing unit 2007. The processor 2007 can be configured to execute various program codes such as the methods such as described herein.

In some embodiments the device 2000 comprises a memory 2011. In some embodiments the at least one processor 2007 is coupled to the memory 2011. The memory 2011 can be any suitable storage means. In some embodiments the memory 2011 comprises a program code section for storing program codes implementable upon the processor 2007. Furthermore in some embodiments the memory 2011 can further comprise a stored data section for storing data, for example data that has been processed or to be processed in accordance with the embodiments as described herein. The implemented program code stored within the program code section and the data stored within the stored data section can be retrieved by the processor 2007 whenever needed via the memory-processor coupling.

In some embodiments the device 2000 comprises a user interface 2005. The user interface 2005 can be coupled in some embodiments to the processor 2007. In some embodiments the processor 2007 can control the operation of the user interface 2005 and receive inputs from the user interface 2005. In some embodiments the user interface 2005 can enable a user to input commands to the device 2000, for example via a keypad. In some embodiments the user interface 2005 can enable the user to obtain information from the device 2000. For example the user interface 2005 may comprise a display configured to display information from the device 2000 to the user. The user interface 2005 can in some embodiments comprise a touch screen or touch interface capable of both enabling information to be entered to the device 2000 and further displaying information to the user of the device 2000. In some embodiments the user interface 2005 may be the user interface for communicating.

In some embodiments the device 2000 comprises an input/output port 2009. The input/output port 2009 in some embodiments comprises a transceiver. The transceiver in such embodiments can be coupled to the processor 2007 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The input/output port 2009 may be configured to receive the signals.

In some embodiments the device 2000 may be employed as at least part of the renderer. The input/output port 2009 may be coupled to headphones (which may be a headtracked or a non-tracked headphones) or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus for assisting spatial rendering for room acoustics, the apparatus comprising:
at least one processor; and
at least one memory storing instructions that, when executed with the at least one processor, cause the apparatus at least to:
obtain at least one reverberation parameter;
determine at least one reverberation ratio parameter at least based on the obtained at least one reverberation parameter;
adjust the at least one reverberation ratio parameter;
obtain at least one audio signal; and
control late reverberation ratio of the obtained at least one audio signal based on the adjusted at least one reverberation ratio parameter.

2. The apparatus as claimed in claim 1, wherein the instructions, when executed with the at least one processor, cause the apparatus to:
provide a filter configured based on the at least one adjusted reverberation ratio parameter; and
apply the filter to the at least one audio signal to generate a late-rendered part of a rendered audio signal.

3. The apparatus as claimed in claim 1, wherein the instructions, when executed with the at least one processor, cause the apparatus to obtain information which indicates whether to use an input reverberation ratio or a ratio calculated based on at least one reverberation parameter.

4. The apparatus as claimed in claim 1, wherein the instructions, when executed with the at least one processor, cause the apparatus to obtain at least one of:
at least one RT60 time;
at least one room or enclosure volume dimension;
at least one pre-delay value; or
at least one diffuse-to-direct ratio value.

5. The apparatus as claimed in claim 4, wherein the instructions, when executed with the at least one processor, cause the apparatus to:
obtain at least one pre-delay value; and
determine a further pre-delay value from the first pre-delay value.

6. The apparatus as claimed in claim 1, wherein the instructions, when executed with the at least one processor, cause the apparatus to set the determined at least one reverberation ratio parameter as the at least one reverberation parameter.

7. The apparatus as claimed in claim 1, wherein the instructions, when executed with the at least one processor, cause the apparatus to:
obtain at least one value; and
apply the at least one value to the at least one reverberation ratio parameter to obtain the at least one adjusted reverberation ratio parameter.

8. The apparatus as claimed in claim 7, wherein the at least one value comprises a decibel offset for the at least one reverberation ratio parameter.

9. The apparatus as claimed in claim 1, wherein the instructions, when executed with the at least one processor, cause the apparatus to determine an approximation polynomial, the approximation polynomial configured to approximate a decay of reverberation energy.

10. The apparatus as claimed in claim 9, wherein the approximation polynomial is one of:
a first order polynomial;
a second order polynomial; and
a third order polynomial.

11. The apparatus as claimed in claim 1, wherein the at least one reverberation ratio parameter comprises at least one of:
at least one late reverberation level parameter;
at least one late reverberation energy ratio;
at least one diffuse-to-total ratio;
at least one reverberant-to-direct ratio, wherein the reverberant-to-direct ratio is measured as level or energy;
at least one total-to-diffuse ratio; or
at least one direct-to-reverberant ratio.

12. A method for an apparatus for assisting spatial rendering for room acoustics, the method comprising:
obtaining at least one reverberation parameter;
determining at least one reverberation ratio parameter at least based on the obtained at least one reverberation parameter;
adjusting the at least one reverberation ratio parameter;
obtaining at least one audio signal; and
controlling late reverberation ratio of the obtained at least one audio signal based on the adjusted at least one reverberation ratio parameter.

13. The method as claimed in claim 12, wherein controlling the late reverberation ratio of the obtained at least one audio signal based on the adjusted at least one reverberation ratio parameter comprises:
providing a filter configured based on the at least one adjusted reverberation ratio parameter; and
applying the filter to the at least one audio signal to generate a late-rendered part of a rendered audio signal.

14. The method as claimed in claim 12, wherein obtaining the at least one reverberation parameter comprises obtaining information which indicates whether to use an input reverberation ratio or a ratio calculated based on the at least one reverberation parameter.

15. The method as claimed in claim 12, wherein obtaining the at least one reverberation parameter comprises obtaining at least one of:
at least one RT60 time;
at least one room or enclosure volume dimension;
at least one pre-delay value; or
at least one diffuse-to-direct ratio value.

16. The method as claimed in claim 15, wherein the obtaining at least one pre-delay value comprises:
obtaining at least one pre-delay value; and
determining a further pre-delay value from the first pre-delay value.

17. The method as claimed in claim 12, wherein determining the at least one reverberation ratio parameter comprises setting the determined at least one reverberation ratio parameter as the at least one reverberation parameter.

18. The method as claimed in claim 12, wherein adjusting the at least one reverberation ratio parameter comprises:
obtaining at least one value; and
applying the at least one value to the at least one reverberation ratio parameter to obtain the at least one adjusted reverberation ratio parameter.

19. The method as claimed in claim 18, wherein the at least one value comprises a decibel offset for the at least one reverberation ratio parameter.

20. The method as claimed in claim 12, wherein adjusting the at least one reverberation ratio parameter comprises determining an approximation polynomial, the approximation polynomial configured to approximate a decay of reverberation energy.

21. (canceled)
